(19) United States
(12) Patent Application Publication
(10) Pub. No.: US 2014/0212767 A1
(43) Pub. Date: Jul. 31, 2014

(54) SOLID BATTERY AND METHOD FOR MANUFACTURING THE SAME

(71) Applicants: Yushi Suzuki, Susono-shi (JP); Shigenori Hama, Sunto-gun (JP)

(72) Inventors: Yushi Suzuki, Susono-shi (JP); Shigenori Hama, Sunto-gun (JP)

(73) Assignee: TOYOTA JIDOSHA KABUSHIKI KAISHA, Toyota-shi, Aichi-ken (JP)

(21) Appl. No.: 14/126,945

(22) PCT Filed: Aug. 5, 2011
(86) PCT No.: PCT/JP2011/067938

§ 371 Date: Dec. 17, 2013

(51) Int. Cl. H01M 10/0562; H01M 10/0525

(52) U.S. Cl. CPC H01M 10/0562; H01M 10/0525
USPC 429/304; 29/623.1

(57) ABSTRACT

Provided is a solid battery which can improve output power and a method for manufacturing the solid battery, the present invention is a solid battery including an electrode body having a cathode layer, an anode layer, and a solid electrolyte layer disposed between the cathode layer and the anode layer and containing a sulfide-based solid electrolyte, wherein the cathode layer and the anode layer are connected via a removable conductive member, and a method for manufacturing the solid battery including the steps of: producing the electrode body; and connecting the cathode layer and the anode layer via the removable conductive member.

### TECHNICAL FIELD

The present invention relates to a solid battery having a solid electrolyte and a method for manufacturing the solid battery.

### BACKGROUND ART

A lithium-ion secondary battery (hereinafter sometimes referred to as “lithium secondary battery”) has a characteristic that it has a higher energy density and is operable at a high voltage compared to other secondary batteries. Therefore, it is used for information devices such as a cellular phone, as a secondary battery which can be easily reduced in size and weight. Nowadays there is also an increasing demand for the lithium-ion secondary battery to be used as a power source for large-scale apparatuses such as electric vehicles and hybrid vehicles.

The lithium-ion secondary battery comprises a cathode layer, an anode layer, and an electrolyte layer disposed between them. An electrolyte to be used in the electrolyte layer is, for example, a non-aqueous liquid or a solid. When the liquid is used as the electrolyte (hereinafter, the liquid being referred to as an “electrolytic solution”), it permeates into the cathode layer and the anode layer easily. Therefore, an interface can be formed easily between the electrolytic solution and active materials contained in the cathode layer and the anode layer respectively, and the battery performance can be easily improved. However, since commonly used electrolytic solutions are flammable, it is necessary to have a system to ensure safety. On the other hand, since electrolytes in solid form (hereinafter referred to as “solid electrolyte”) are nonflammable, the above system can be simplified. As such, lithium-ion secondary batteries having a layer containing a solid electrolyte have been suggested. (hereinafter, the layer being referred to as “solid electrolyte layer” and the battery being referred to as “solid battery”).

As a technique related to such a solid battery, Patent Document 1 discloses a technique related to a battery module comprising an assembled battery in which a plurality of unit cells of lithium-ion secondary battery are connected, wherein an electrolyte of the lithium-ion secondary battery is an inorganic solid electrolyte, and means to prevent over discharge of the lithium-ion secondary battery is not provided, and a technique related to a battery module comprising an assembled battery in which a plurality of unit cells of lithium-ion secondary battery are connected, wherein an electrolyte of the lithium-ion secondary battery is an inorganic solid electrolyte and an means to prevent over discharge of the lithium-ion secondary battery is provided.

### CITATION LIST

### Patent Literatures

Patent Document 1: Japanese Patent Application Laid-Open Publication No. 2010-225581

### SUMMARY OF THE INVENTION

### Problems to be Solved by the Invention

According to the technique disclosed in Patent Document 1, there is a problem that output power of the battery is reduced when the battery is left for a while after charged.

Accordingly, an object of the present invention is to provide a solid battery which can improve output power and a method for manufacturing the solid battery.

### Means for Solving the Problems

In order to solve the above problems, the present invention takes the following means.

Namely, a first aspect of the present invention is a solid battery comprising: a cathode layer; an anode layer; and a solid electrolyte layer disposed between the cathode layer and the anode layer and containing a sulfide-based solid electrolyte; wherein the cathode layer and the anode layer are connected via a removable conductive member.

A second aspect of the present invention is a method for manufacturing a solid battery comprising an electrode body having a cathode layer, an anode layer, and a solid electrolyte layer disposed between the cathode layer and the anode layer and containing a sulfide-based solid electrolyte, the method comprising the steps of: manufacturing the electrode body; and connecting the cathode layer and the anode layer via a removable conductive member.

### EFFECTS OF THE INVENTION

In the first aspect of the present invention, the cathode layer and the anode layer are connected via a removable conductive member. For this reason, it is possible to reduce battery voltage before the solid battery is charged, and when the solid battery is charged, the solid battery can be charged with the conductive member removed. Reducing the battery voltage before charging makes it possible to reduce resistance of the battery, whereby output power of the battery can be improved. Therefore, according to the first aspect of the present invention, it is possible to provide a solid battery that can improve output power.

The second aspect of the present invention comprises a step to connect the cathode layer and the anode layer via a removable conductive member. By connecting the cathode layer and the anode layer via the conductive member to reduce battery voltage before the solid battery is charged, it is possible to reduce resistance of the battery. Reducing the battery voltage over a long period of time makes it possible to reduce battery resistance easily. Here, the solid battery, like other batteries, needs a long period of time from manufacturing the electrode body until starting actual use of the solid battery, because the solid battery undergoes steps of transportation, storage, assembly and so on between manufacturing of the solid battery and the starting of actual use. Since the second aspect of the present invention comprises a step to connect the cathode layer and the anode layer via the removable conductive member, it is possible to reduce sufficiently the battery voltage using the time before the battery is used. Therefore, according to the second aspect of the present invention, it is possible to provide a method for manufacturing the solid battery which can improve output power.

### BRIEF DESCRIPTION OF THE DRAWINGS

FIG. 1 is a view illustrating a solid battery 10.

FIG. 2 is a cross-sectional view taken along the line shown by II-II of FIG. 1.

FIG. 3 is a view illustrating a solid battery 10x.

FIG. 4 is a flowchart showing a method for manufacturing a solid battery.

FIG. 5 is a graph showing results of measurement of battery resistances.

### MODES FOR CARRYING OUT THE INVENTION

In a conventional battery in which an electrolytic solution was used (hereinafter simply referred to as “conventional battery”), the electrode is eluted in an over-discharged state and thus the battery rapidly deteriorates. Therefore, in the conventional battery, an over discharge prevention circuit and the like needs to be provided. Further, in the conventional battery, if short circuit occurs with the battery having residual electric power, a large amount of current flows and thus heat is produced. Therefore, an insulation cover also needs to be provided in the conventional battery. On the other hand, the inventors of the present invention found out that, in a solid battery, by keeping the battery voltage reduced for example to 1V or less before charging, it is possible to reduce the battery resistance after charging, which makes it possible to improve output power of the battery as a result. The reason is considered as follows. If the solid battery starts to be charged shortly after manufacturing of the battery, oxidation reaction is promoted in the cathode layer and thus a layer that has a high electrical resistance (hereinafter referred to as “high resistance layer”) is formed between the cathode active material and the solid electrolyte. In contrast, if the battery is kept for a predetermined period before charging with the cathode layer being in a reduction condition after manufacturing of the battery, a layer having a lower electrical resistance than the resistance of the high resistance layer described above is formed between the cathode active material and the solid electrolyte, which prevents forming of the high resistance layer, whereby it is possible to reduce the battery resistance. Reducing the battery voltage before charging also makes it possible to inhibit the situation in which a large amount of current flows thereto create heat. Therefore, it is considered that, by reducing the battery voltage before charging, neither an over discharge prevention circuit nor an insulation cover to prevent short circuit is needed.

It is considered that storing the battery for a long period of time after manufacturing of the battery makes it possible to reduce the battery voltage by self discharge. However, if a step to store the battery for a long period of time is additionally provided in manufacturing steps of the battery, the manufacturing efficiency of the battery tends to be degraded. The inventors of the present invention therefore have conducted a study on a structure of a battery which can inhibit degradation of the manufacturing efficiency but at the same time can improve output power, and a method for manufacturing the battery. Normally, there is a long period of time needed from completion of the electrode body until starting of actual use of the battery because the battery undergoes steps of transportation, storage, assembly and so on. Therefore, it is considered that a configuration in which the cathode layer and the anode layer are connected via a removable conductive member in advance before charging of the battery, and the battery is charged after the removable conductive member is removed from the battery makes it possible to provide a solid battery which can improve output power and a method for manufacturing the solid battery. The inventors have completed the present invention based on these findings.

Hereinafter, the present invention will be described with reference to the drawings. It should be noted, however, that the embodiments shown below are examples of the present invention and the present invention is not limited to these embodiments.

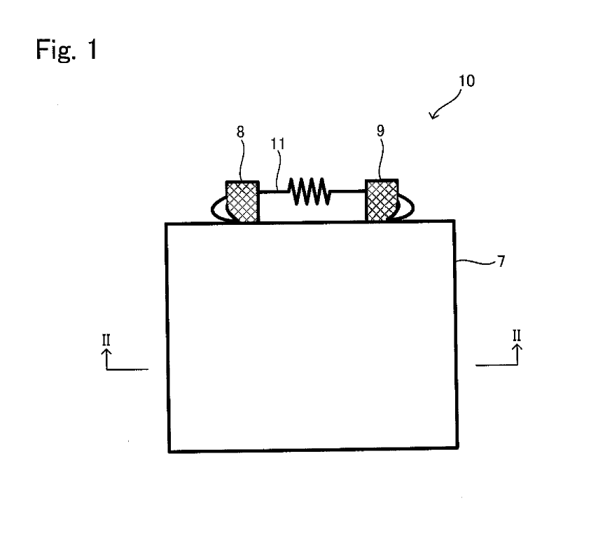

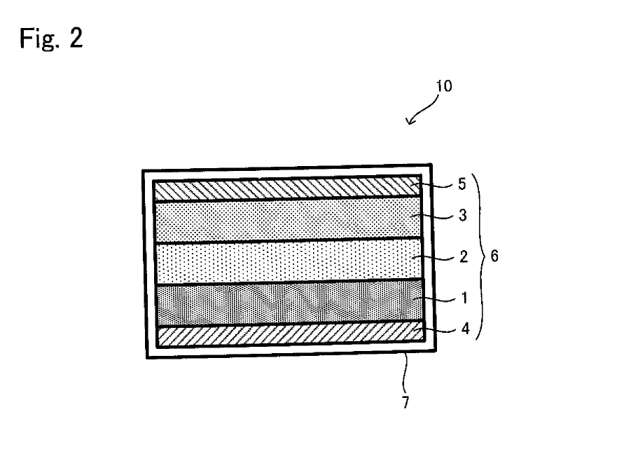

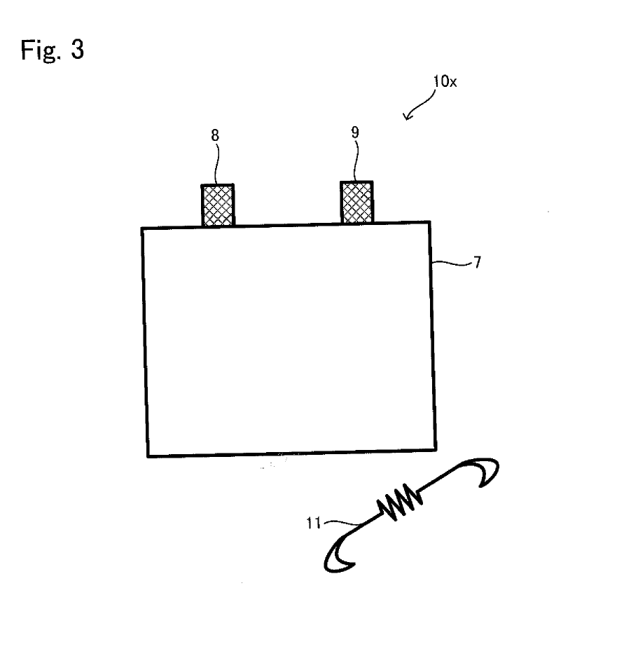

FIGS. 1 and 3 are views illustrating a solid battery 10 of the present invention, and FIG. 2 is a cross-sectional view taken along the line shown by of FIG. 1. As shown in FIGS. 1 and 2, the solid battery 10 comprises: an electrode body 6 having a cathode layer 1, an anode layer 3, a solid electrolyte layer 2 disposed between the cathode layer 1 and the anode layer 3, a cathode current collector 4 connected to the cathode layer 1, and an anode current collector 5 connected to the anode layer 3; and an exterior body 7 to house the electrode body 6. A cathode terminal 8 is connected to the cathode current collector 4, and an anode terminal 9 is connected to the anode current collector 5 respectively. Each of the cathode terminal 8 and the anode terminal 9 is disposed in a manner that one end thereof is positioned outside the exterior body 7. The cathode terminal 8 and the anode terminal 9 are connected via a removable conductive member 11 (hereinafter sometimes referred to as “conductive hook 11”).

The cathode terminal 8 and the anode terminal 9 in the solid battery 10 are connected to each other via the conductive hook 11. Therefore, for example, the solid battery 10 is charged after being turned into a solid battery 10x in which the conductive hook 11 is removed from the cathode terminal 8 and the anode terminal 9 as shown in FIG. 3.

Connecting the cathode terminal 8 and the anode terminal 9 via the conductive hook 11 makes it possible to electrically connect the cathode terminal 8 and the anode terminal 9. Therefore, by keeping the solid battery 10 after manufacturing in a state shown in FIG. 1, the voltage of the solid battery 10 can be reduced. As described below, since reducing battery voltage before charging makes it possible to reduce battery resistance, according to the present invention, it is possible to provide the solid battery 10 that can improve output power.

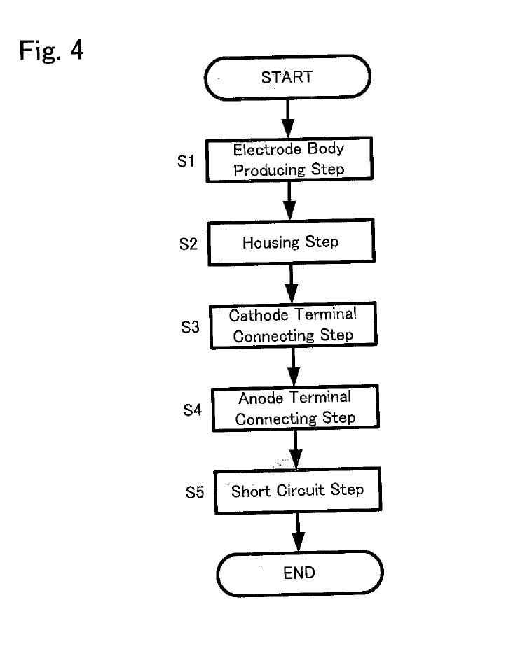

FIG. 4 is a flowchart showing a method for manufacturing a solid battery of the present invention (hereinafter sometimes referred to as “manufacturing method of the present invention”). Hereinafter, the manufacturing method of the present invention will be described with reference to FIGS. 1 and 4. The manufacturing method of the present invention shown in FIG. 4 has: electrode body producing step (S1); housing step (S2); cathode terminal connecting step (S3); anode terminal connecting step (S4); and short circuit step (S5).

The electrode body producing step (hereinafter sometimes referred to as “S1”) is a step to produce the electrode body 6 comprising the cathode layer 1, the anode layer 3, the solid electrolyte layer 2 disposed between the cathode layer 1 and the anode layer 3, the cathode current collector 4 connected to the cathode layer 1, and the anode current collector 5 connected to the anode layer 3. The configuration of S1 is not particularly limited as long as the electrode body 6 can be produced. In S1, for example, the solid electrolyte layer 2 may be produced by: making a solid electrolyte; filling the solid electrolyte in a predetermined mold; and pressing the solid electrolyte. Also, in S1, the cathode layer 1 may be produced for example by: making a cathode composite by mixing a cathode active material, a solid electrolyte, and a conductive material and a binder if needed; laminating the cathode composite to one face of the solid electrolyte layer 2 disposed in the mold; and pressing the cathode composite. Also, in S1, the anode layer 3 may be produced for example by: making an anode composite by mixing an anode active material, a solid electrolyte, and a conductive material and a binder if needed; laminating the anode composite to the other face of the solid electrolyte layer 2 (opposite side of the face where the cathode layer 1 is to be formed) disposed in the mold; and pressing the anode composite. After the solid electrolyte layer 2 is disposed between the cathode layer 1 and the anode layer 3 in this way, the electrode body 6 may be produced by making the cathode current collector 4 have contact with the cathode layer 1 and the anode current collector 5 have contact with the anode layer 3. S1 may be a step to produce the electrode body 6 in this way for example.

The housing step (hereinafter referred to as “S2”) is a step to house the electrode body 6 produced in S1 in the exterior body 7. For example, S2 may be a step to: house the electrode body 6 in the exterior body 7 in a manner that one end of each of the cathode current collector 5 and the anode current collector 6 is disposed outside the exterior 7; and seal off the exterior body 7 reducing the pressure in the exterior body 7.

The cathode terminal connecting step (hereinafter referred to as “S3”) is a step to connect the cathode layer 1 and the cathode terminal 8. For example, S3 may be a step to connect the cathode layer 1 and the cathode terminal 8 via the cathode current collector 5 by connecting the cathode current collector 5 whose one end is disposed outside the exterior body 7 in S2 and the cathode terminal 8 (for example, by covering the one end of the cathode current collector 5 positioned outside the exterior body 7 by the cathode terminal 8).

The anode terminal connecting step (hereinafter referred to as “S4”) is a step to connect the anode layer 3 and the anode terminal 9. For example, S4 maybe a step to connect the anode layer 3 and the anode terminal 9 via the anode current collector 6 by connecting the anode current collector 6 whose one end is disposed outside the exterior body 5 and the anode terminal 9 (for example, by covering the one end of the anode current collector 6 positioned outside the exterior body 7 by the anode terminal 9).

The short circuit step (hereinafter sometimes referred to as “S5”) is a step to electrically connect the cathode layer 1 and the anode layer 3 by connecting the cathode terminal 8 and the anode terminal 9 using the conductive hook 11 that can be removed. By undergoing S1 to S5, the solid battery 10 in which the cathode layer 1 and the anode layer 3 are electrically connected via the conductive hook 11 can be manufactured. By undergoing S5, the cathode layer 1 and the anode layer 3 are electrically connected via the conductive hook 11, whereby the battery voltage of the solid battery 10 can be reduced. Reducing the battery voltage before charging makes it possible to reduce the battery resistance, therefore according to the present invention, it is possible to provide a method for manufacturing a solid battery, the method can manufacture the solid battery 10 which can improve output power.

In the present invention, as the cathode active material to be contained in the cathode layer 1, a known active material which can be contained in a cathode layer of a lithium-ion secondary battery may be adequately used. Examples of such a cathode active material may include: layered active materials such as lithium cobalt oxide (LiCoO₂) and lithium nickel oxide (LiNiO₂); olivine type active materials such as olivine type lithium iron phosphate (LiFePO₄); spinel type active materials such as spinel type oxide manganese lithium (LiMn₂O₄) and the like. Also, as the solid electrolyte to be contained in the cathode layer 1, a known solid electrolyte which can be contained in a cathode layer of a lithium-ion secondly battery may be adequately used. Examples of such a solid electrolyte may include sulfide-based solid electrolytes such as Li₂S-P₂S₅ prepared by mixing Li₂S and P₂S₅, and Li₃PS₄. Also the configuration of the solid electrolyte to be contained in the cathode layer 1 is not particularly limited, and the solid electrolyte may be a crystalline solid electrolyte, an amorphous solid electrolyte, or a glass ceramic. Other than this, the cathode layer 1 may contain a binder to bond the active material and the solid electrolyte and an electrical conducting material to improve electrical conductivity. As the binder that can be contained in the cathode layer 1, styrene-butadiene rubber (SBR) and the like may be exemplified. As the electrical conducting material that can be contained in the cathode layer 1, a vapor-grown carbon fiber (VGCF. “VGCF” is a registered trademark of Showa Denko K.K. The same applied hereinafter), carbon materials such as carbon black, and metallic materials that can endure environment upon using a solid battery may be exemplified. The thickness of the cathode layer 1 is not particularly limited, and may be same as a thickness of a cathode layer of a known solid battery.

In the present invention, as a solid electrolyte to be contained in the solid electrolyte layer 2, a known solid electrolyte that can be used for a solid battery may be adequately used. Examples of such a solid electrolyte may include the solid electrolytes that can be contained in the cathode layer 1 described above and the like. Also, the thickness of the solid electrolyte layer 2 is not particularly limited, and may be same as a thickness of a solid electrolyte layer of a known solid battery.

Also, in the present invention, as the anode active material to be contained in the anode layer 3, a known active material that can be contained in an anode layer of a lithium-ion secondary battery may be adequately used. Examples of such an active material may include graphite and the like. As the solid electrolyte to be contained in the anode layer 3, a known solid electrolyte that can be contained in an anode layer of a lithium-ion secondary battery may be adequately used. Examples of such a solid electrolyte may include the solid electrolytes that can be contained in the cathode layer 1 described above and the like. Other than this, the anode layer 3 may contain a binder to bond the anode active material and the solid electrolyte, and an electrical conducting material to improve electrical conductivity. As the binder and the electrical conductive material that can be contained in the anode layer 3, the binders and electrical conductive materials that can be contained in the cathode layer 1 described above and the like may be exemplified. The thickness of the anode layer 3 is not particularly limited, and may be same as a thickness of an anode layer of a known solid battery.

In the present invention, the cathode current collector 4 and the anode current collector 5 may be composed of a known conductive material which can be used as an anode current collector and a cathode current collector of a lithium-ion secondary battery. As such a conductive material, a metallic material including at least one or more elements selected from the group consisting of Cu, Ni, Al, V, Au, Pt, Mg, Fe, Ti, Co, Cr, Zn, Ge, and In may be exemplified. Also, the cathode current collector 4 and the anode current collector 6 may be in a form of metallic foil, metallic mesh or the like for example.

In the present invention, as the exterior body 7, a laminate film or the like which is used when an electrode body of a lithium-ion secondary battery is sealed with reducing inner-pressure may be adequately used. Examples of a material composing such a laminate film may include: resin films such as polyethylene, polyvinyl fluoride, polyvinylidene chloride; metal vapor-deposited films in which metal such as aluminum is vapor-deposited onto the surface of these resin films and the like.

In the present invention, the cathode terminal 8 and the anode terminal 9 may be composed of a known conductive material that can be used as a cathode terminal and an anode terminal of a lithium-ion secondary battery. Examples of a conductive material that can be used for the cathode terminal 8 and the anode terminal 9 may include the metal materials described above, carbon fibers typified by carbon fiber reinforced plastic (CFRP) and the like.

In the present invention, the configuration of the conductive hook 11 is not particularly limited as long as the cathode layer 1 and the anode layer 3 can be kept in a state being electrically conducted. For example, the conductive hook 11 may be a member to electrically connect the cathode terminal 8 and the anode terminal 9 with a state in which force is applied in directions to move the cathode terminal 8 and the anode terminal 9 close to each other with an elastic material typified by a spring and so on.

In the present invention, the battery voltage of the solid battery 10 in which the cathode layer 1 and the anode layer 3 are electrically connected via the conductive hook 11 before charging is not particularly limited. However, in view of making a configuration in which output power of the solid battery 10 is easily improved and so on, the battery voltage is preferably 1V or less, and more preferably 0.5V or less.

In the manufacturing method of the present invention, it is not particularly limited when to carry out S5 as long as the cathode layer 1 and the anode layer 3 can be electrically connected via the conductive hook 11. For example, S5 may be carried out right after S4, may be when the solid battery is at the time of transportation, may be when the solid battery is stored, or may be when the battery is to be assembled.

In the above description regarding the present invention, a configuration in which the conductive hook 11 is used. However, the removable conductive member to connect the cathode layer and the anode layer is not limited to this configuration. The present invention can be configured such that a known metallic wire typified by a copper wire and so on, or a known conductive tape typified by a copper foil tape and so on is used as the removable conductive member, and the cathode layer and the anode layer are connected by twisting the metallic wire or the conductive tape to the cathode terminal and the anode terminal.

### EXAMPLES

Solid batteries were made by the manufacturing method of the present invention and a conventional manufacturing method, and their performances were evaluated. The methods for manufacturing the solid batteries and results of the performance evaluation were shown below.

### Preparation of a Solid Electrolyte

Li₂S (manufactured by Nippon Chemical Industrial) and P₂S₅ (manufactured by Aldrich) were used as starting ingredients, and 0.7656 g of Li₂S and 1.2344 g of P₂S₅ were weighed. Next, the weighed ingredients were mixed in an agate mortar for 5 minutes. After that, 4 g of heptane was added to the mixture and mechanical milling was carried out using a planetary ball mill for 40 hours, whereby Li₂S-P₂S₅ as a sulfide-based solid electrolyte was prepared.

### Production of an Electrode Material

A cathode composite (an electrode material)

A cathode composite was obtained by mixing weighed 12. mg of a cathode active material (LiNi_{1/3}Co_{1/3}Mn_{1/3}O₂, manufactured by Nichia Corporation), 0.51 mg of VGCF (manufactured by Showa Denko K.K.), and 5.03 mg of the solid electrolyte (Li₂S-P₂S₅) prepared by the above step.

An anode composite (an electrode material)

An anode composite was obtained by mixing weighed 9.06 mg of an anode active material (graphite, manufactured by Mitsubishi Chemical Corporation) and 8.24 mg of the solid electrolyte (Li₂S-P₂S₅) prepared by the above step.

### Production of an Electrode Body and Evaluation of Battery Performance

In a mold having an open portion of 1 cm² capable of filling materials, 18 mg of the solid electrolyte (Li₂S-P₂S₅) prepared by the above step was weighed and filled, then pressed at a pressure of 100 MPa whereby a solid electrolyte layer was made. After that, 17.57 mg of the cathode composite described above was disposed to one side of the solid electrolyte layer and pressed at a pressure of 100 MPa, whereby a cathode layer was made. Then, 17.3 mg of the anode composite described above was disposed to the other side of the solid electrolyte layer (the side where the cathode composite was not disposed), and pressed at a pressure of 400 MPa, whereby an anode layer was made. After that, a cathode current collector (an Al foil having a thickness of 15 μm, manufactured by Nippon Foil Mfg. Co., Ltd.) was made to have contact with the cathode layer, and an anode current collector (a Cu foil having a thickness of 10 μm, manufactured by Nippon Foil Mfg. Co., Ltd.) was made to have contact with the anode layer, whereby an electrode body was made.

### Example 1

After the electrode body was made by the above step, the electrode body was discharged with a constant current of 1.5 mA down to 0V, and thereafter discharged with a constant voltage of 0V for 10 hours . After that, confirming that the open-circuit voltage was 0.5V or less (specifically, 0.3V), the electrode was kept under a temperature of 25° C. for 24 hours.

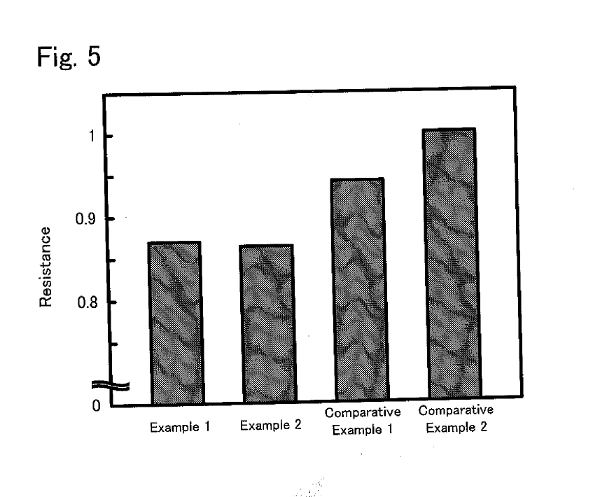

Then, the electrode body was charged with a constant current of 0.3 mA up to 4.2V, and thereafter discharged with a current of 0.3 mA down to 2.5V. After that, the electrode body was charged to 3.6V to adjust the voltage then impedance analysis was carried out by using a solartron to obtain the resistance value. The result was shown in FIG. 5. The vertical axis of FIG. 5 represents resistance defining the resistance of the electrode body of the Comparative Example 2 described later as 1. It should be noted that, the discharge was performed with the constant current of 1.5 mA, but the current value of the constant current is not limited to this. However, the current value is preferably between 0.1 mAh to 10 mAh, since a long time is required if the current value is small, a large amount of overvoltage is created if the current value is large.

### Example 2

The cathode layer and the anode layer of the electrode body produced by the above step were electrically connected by a removable conductive member (a copper wire), and kept with an open-circuit voltage of 0V for 10 hours. After that, confirming that the open-circuit voltage was 0.3V, the electrode body was kept under a temperature of 25° C. for 24 hours. Thereafter, the electrode body was charged with a constant current of 0.3 mA up to 4.2V, then discharged with a current of 0.3 mA down to 2.5V. After that, the electrode was charged to 3.6V to adjust the voltage then impedance analysis was carried out by using a solartron to obtain the resistance value. The result was shown in FIG. 5.

### Comparative Example 1

The open-circuit voltage of the electrode body produced by the above step was measured to confirm it was 1V or less (specifically, 0.9V), and the electrode body was kept under a temperature of 25° C. for 24 hours. Thereafter, the electrode body was charged with a constant current of 0.3 mA up to 4.2V then discharged with a current of 0.3 mA down to 2.5V. After that, the electrode was charged to 3.6V to adjust the voltage then impedance analysis was carried out by using a solartron to obtain the resistance value. The result was shown in FIG. 5.

### Comparative Example 2

After 4 hours passed since the electrode body had been produced by the above step, the electrode was charged with a constant current of 0.3 mA up to 4.2V, then discharged with a current of 0.3 mA down to 2.5V. After that, the electrode body was charged to 3.6V to adjust the voltage then impedance analysis was carried out by using a solartron to obtain the resistance value. The result was shown in FIG. 5.

### RESULTS

As shown in FIG. 5, each electrode body of the Example 1 and Example 2 in which the cathode layer and the anode layer were connected via the conductive member had a smaller resistance than that of each electrode body of the Comparative Example 1 and the Comparative Example 2. Also, the electrode body of the Example 1 that was discharged with a constant current down to 0V, and the electrode body of Example 2 in which the cathode layer and the anode layer were electrically connected via the removable conductive member each had a smaller resistance than that of the electrode body of the Comparative Example 1 that was not discharged at a constant current and was not provide with the removable conductive member. Further, the electrode body of the Example 2 in which the cathode layer and the anode layer were electrically conducted by the removable conductive member had the smallest resistance. As shown above, by connecting the cathode layer and the anode layer electrically before charging, it was possible to reduce the battery resistance and thereby improve output power of the solid battery.

The present invention has been described above as to the embodiments that are supposed to be practical as well as preferable at present. However, it should be understood that the present invention is not limited to the embodiments disclosed in the specification of the present application and can be appropriately modified within the range that does not depart from the gist or spirit of the invention, which can be read from the appended claims and the overall specification, and that a solid battery and a method for manufacturing the solid battery with such modifications are also encompassed within the technical range of the present invention.

### Description of the Reference Numerals

1 cathode layer

2 solid electrolyte layer

3 anode layer

4 cathode current collector

5 anode current collector

6 electrode body

7 exterior body

8 cathode terminal

9 anode terminal

10,10x solid battery

11 conductive hook (conductive member)

1. A solid battery comprising an electrode body having a cathode layer, an anode layer, and a solid electrolyte layer disposed between the cathode layer and the anode layer and containing a sulfide-based solid electrolyte, wherein the cathode layer and the anode layer are connected via a removable conductive member.

2. A method for manufacturing a solid battery comprising an electrode body having a cathode layer, an anode layer, and a solid electrolyte layer disposed between the cathode layer and the anode layer and containing a sulfide-based solid electrolyte, the method comprising the steps of: producing the electrode body; and connecting the cathode layer and the anode layer via a removable conductive member.
